(19) United States
(12) Patent Application Publication
(10) Pub. No.: US 2021/0402700 A1
(43) Pub. Date: Dec. 30, 2021

(54) APPARATUS FOR MANUFACTURING A THREE-DIMENSIONAL OBJECT

(71) Applicant: Rapid Shape GmbH, Heimsheim (DE)

(72) Inventors: Andreas Schultheiss, Muehlacker (DE); Andreas Geitner, Leonberg (DE)

(21) Appl. No.: 17/444,852

(22) Filed: Aug. 11, 2021

Related U.S. Application Data
(63) Continuation of application No. PCT/EP2020/053945, filed on Feb. 14, 2020.

(30) Foreign Application Priority Data
Feb. 14, 2019 (DE) 10 2019 103 815.4

(51) Int. Cl. B29C 64/379; B33Y 30/00; B33Y 40/00; B29C 64/227

(52) U.S. Cl. CPC B29C 64/379; B29C 64/227; B33Y 40/00; B33Y 30/00

(57) ABSTRACT

The present invention relates to an apparatus for manufacturing a three-dimensional object by solidifying, in particular in layers or continuously, a material that is solidifiable by radiation, which apparatus comprises a support device for holding the solidified three-dimensional object, wherein the apparatus comprises a detaching device for automatically detaching a three-dimensional object held on the support device, wherein the apparatus comprises a protective device for protecting the detaching device, in particular in the building position.

### CROSS-REFERENCE TO RELATED APPLICATIONS

This application is a continuation of international application number PCT/EP2020/053945 filed on Feb. 14, 2020 and claims the benefit of German application number 10 2019 103 815.4 filed on Feb. 14, 2019, which are incorporated herein by reference in their entirety and for all purposes.

### FIELD OF THE INVENTION

The present invention relates to apparatuses for manufacturing a three-dimensional object by solidifying, in particular in layers or continuously, a material that is solidifiable by radiation generally, and more specifically to a an apparatus for manufacturing a three-dimensional object by solidifying, in particular in layers or continuously, a material that is solidifiable by radiation, which apparatus comprises a support device for holding the solidified three-dimensional object.

### BACKGROUND OF THE INVENTION

Apparatuses of the kind described at the outset, in the form of so-called 3D-printers, are known, e.g., from DE 10 2013 107 571 A1. After completion, i.e., curing, the solidified three-dimensional objects are held on the support device and are yet contaminated with non-solidified solidifiable material. When removing the three-dimensional objects from the support device, there is the problem, in particular, that an operator or user of the apparatus can become contaminated.

### SUMMARY OF THE INVENTION

In a first aspect of the invention, an apparatus for manufacturing a three-dimensional object by solidifying, in particular in layers or continuously, a material that is solidifiable by radiation. The apparatus comprises a support device for holding the solidified three-dimensional object. The apparatus comprises a detaching device for automatically detaching a three-dimensional object held on the support device. The apparatus comprises a protective device for protecting the detaching device, in particular in the building position.

In a second aspect of the invention, an apparatus for manufacturing a three-dimensional object by solidifying, in particular in layers or continuously, a material that is solidifiable by radiation. The apparatus comprises a support device for holding the solidified three-dimensional object. The the apparatus comprises a detaching device for automatically detaching a three-dimensional object held on the support device. The detaching device comprises at least one detaching element. The at least one detaching element and the support device are arranged or formed so as to be moveable relative to one another. The at least one detaching element comprises a blade with a cutter, or the at least one detaching element is configured in the form of a blade with at least one cutter. The at least one detaching element and a support face, defined by the support device, on which the three-dimensional object is held form a detaching angle. The apparatus comprises a detaching angle setting device for setting the detaching angle.

### BRIEF DESCRIPTION OF THE DRAWING FIGURES

The foregoing summary and the following description may be better understood in conjunction with the drawing figures, of which:

FIG. 1: shows a schematic perspective, partially broken total view of an embodiment of an apparatus for manufacturing a three-dimensional object;

FIG. 2: shows a perspective view of a part of the apparatus from FIG. 1 with a support plate that has been dipped into a container with solidifiable material during the formation of a three-dimensional object;

FIG. 3: shows a view similar to FIG. 2 with a completed three-dimensional object held on the support plate;

FIG. 4: shows a further perspective view of the part, depicted in FIGS. 2 and 3, of the apparatus from FIG. 1 during the detachment of the three-dimensional object from the support plate;

FIG. 5: shows a partially cut view of the arrangement from FIGS. 2 to 4 from the front before the detachment of the three-dimensional object from the support plate;

FIG. 6: shows an enlarged section view of the region A in FIG. 5;

FIG. 7: shows a view similar to FIG. 6 of a three-dimensional object partially detached from the support plate;

FIG. 8: shows a view similar to FIG. 7 after complete detachment of the three-dimensional object from the support plate;

FIG. 9: shows a schematic perspective, partially broken total view of a further embodiment of an apparatus for manufacturing a three-dimensional object;

FIG. 10: shows a perspective view of a part of the apparatus from FIG. 9;

FIG. 11: shows a view of the arrangement from FIG. 10 in the direction of the arrow B;

FIG. 12: shows a view of the arrangement from FIG. 11 in the direction of the arrow C;

FIG. 13: shows an enlarged section view of the region D from FIG. 9;

FIG. 14: shows a cut view along line 14-14 in FIG. 12;

FIG. 15: shows an enlarged partial view of the arrangement from FIG. 14 before separating off a three-dimensional object held on the support plate;

FIG. 16: shows a view similar to FIG. 15 during the separation of the three-dimensional object from the support plate;

FIG. 17a: shows a schematic partial cut view of an embodiment of a detaching element in cooperation with a support plate before the detachment of a three-dimensional object;

FIG. 17b: shows a view in the direction of the arrow E in FIG. 17a;

FIG. 18a: shows a schematic partial cut view of a further embodiment of a detaching element in cooperation with a support plate before the detachment of a three-dimensional object;

FIG. 18b: shows a view in the direction of the arrow F in FIG. 18a;

FIG. 19a: shows a schematic partial cut view of a further embodiment of a detaching element in cooperation with a support plate before the detachment of a three-dimensional object;

FIG. 19b: shows a view in the direction of the arrow G in FIG. 19a;

FIG. 20a: shows a schematic partial cut view of a further embodiment of a detaching element in cooperation with a support plate before the detachment of a three-dimensional object;

FIG. 20b: shows a view in the direction of the arrow H in FIG. 20a;

FIG. 21a: shows a schematic partial cut view of a further embodiment of a detaching device in cooperation with a support plate before the detachment of a three-dimensional object;

FIG. 21b: shows a view in the direction of the arrow H in FIG. 21a; and

FIG. 22: shows a schematic view of a further embodiment of an apparatus for manufacturing a three-dimensional object.

### DETAILED DESCRIPTION OF THE INVENTION

Although the invention is illustrated and described herein with reference to specific embodiments, the invention is not intended to be limited to the details shown. Rather, various modifications may be made in the details within the scope and range of equivalents of the claims and without departing from the invention.

The present invention relates to an apparatus for manufacturing a three-dimensional object by solidifying, in particular in layers or continuously, a material that is solidifiable by radiation, which apparatus comprises a support device for holding the solidified three-dimensional object, wherein the apparatus comprises a detaching device for automatically detaching a three-dimensional object held on the support device, wherein the apparatus comprises a protective device for protecting the detaching device, in particular in the building position.

Further developing an apparatus for manufacturing a three-dimensional object in the described manner has the advantage, in particular, that an operator does not have to come into contact with the apparatus, i.e., in particular not with the support device and not with the three-dimensional object that is formed. In particular, such a detaching device makes it possible to completely automate the manufacture of three-dimensional objects. Production times can thus be significantly reduced because a removal operation of manufactured three-dimensional objects can be performed in a defined and thus standardized manner. Directly after detaching the three-dimensional object using the detaching device, the apparatus can be used to manufacture further three-dimensional objects.

The apparatus can be formed in a simple manner if the detaching device comprises at least one detaching element and if the at least one detaching element and the support device are arranged or formed so as to be moveable relative to one another. For detaching the three-dimensional object from the support device, the at least one detaching element and the support device therefore only have to be moved relative to one another. This enables a moveable arrangement or configuration of the at least one detaching element and the support device. In particular, two or more detaching elements may be provided. For example, for an optimal separation of the manufactured three-dimensional object, two detaching elements or more can be moved one after the other relative to the support device or the support device relative to the detaching elements.

A three-dimensional object held on the support device can be detached in a simple and secure manner if the at least one detaching element comprises one or more blades with a cutter, or if the at least one detaching element is configured in the form of a blade with at least one cutter. In particular, the cutter may be arranged and moved relative to the support device in such a way that it abuts against the support device or is moved relative to the support device at a small distance therefrom. For example, the blade may be configured in the form of a double blade with two cutters. The detaching element may bear or comprise, in particular, one, two, three, or more blades. In particular, the detaching element may comprise a support element for one or more blades.

It is advantageous if the blade has a blade body with a blade body front side and a blade body rear side, and if the blade body has at least one side face that is beveled in relation to the blade body front side and/or the blade body rear side for forming the cutter with a cutting edge. In particular, the blade body may have two beveled side faces. The cutting edge preferably defines an acute angle between the beveled side faces. In particular, all blades of the detaching element, if said element bears a plurality of blades, may be configured in the described manner.

It is favorable if the at least one beveled side face forms an obtuse angle with the blade body front side. In this way, a transition between the beveled side face and the blade body front side can be formed very flat. In particular, a rounding of an edge between the beveled side face and the blade body front side can be formed in a simple manner.

It is further advantageous if the blade body has two beveled side faces for forming the cutter, and if a line of intersection of the two beveled side faces defines the cutting edge. A cutting edge that is sharpened on both sides can be formed in this way.

It is advantageous if the at least one beveled side face forms an obtuse angle with the blade body rear side. This enables a flat transition between the beveled side face and the blade body rear side. In particular, this transition, which forms an edge in the case of planar faces, can be rounded in a simple manner.

It is favorable if the blade body has only one beveled side face, which forms an acute angle with the blade body rear side, and if a line of intersection of the beveled side face with the blade body rear side defines the cutting edge. This configuration enables the formation of a cutting edge in a simple manner.

The detaching element can be formed in a simple and cost-effective manner if the blade body front side and the blade body rear side extend in parallel to one another. In particular, the detaching element can thus be made from a flat sheet metal.

In accordance with a further preferred embodiment of the invention, provision may be made that the cutting edge is defined by two intersecting cutting faces that delimit the cutter and intersect at a cutting angle, and in the cutting angle has a value in a range from about 10° to about 50°. In particular, the cutting angle may have a value in a range from about 20° to about 40°. The cutting faces may be formed, in particular, by beveled side faces or the blade body rear side or the blade body front side. A particularly small cutting angle has the advantage that when moving the detaching element and the support device relative to one another, only small forces, in particular shear forces, act on the manufactured three-dimensional object. In other words, a detachment or scraping-off of the three-dimensional object from the support device is possible in a simple manner and with low risks with respect to damaging the three-dimensional object.

It is advantageous if the at least one detaching element, for and when detaching the three-dimensional object, abuts with the cutting edge against the support device or is arranged at a small distance from the support device. The three-dimensional object that is formed can be scraped off, in particular, when the cutting edge abuts against the support device. For example, the support device comprises a planar support plate to which the three-dimensional object adheres. With the cutting edge at a small distance from the support device, in particular, one or a few layers of the three-dimensional object can be left on the support device in a targeted manner. This is advantageous, in particular, when, for example, the form of a first or of a few layers for forming the three-dimensional object cannot be ensured in the desired manner as defined. Further, in the case of a detaching device that comprises two or more cutting edges, the cutting edges can abut, on the one hand, against the support device and, on the other hand, be arranged at a small distance from the support device. This enables an improved detachment of the three-dimensional object from the support device.

The at least one detaching element and a support face defined by the support device, on which support face the three-dimensional object is held, preferably form a detaching angle. In particular, a minimal deformation of the three-dimensional object can be further minimized if the detaching angle is as small as possible.

It is advantageous if one of the two cutting faces faces away from the support face and this cutting face and the support face form between them the detaching angle. The detaching angle thus forms a wedge angle, which defines the detachment or lifting-off or scraping-off of the three-dimensional object from the support device. In particular, a deformation of the three-dimensional object during detachment can be minimized by appropriately selecting the detaching angle.

It is favorable if the detaching angle has a value in a range from about 0° to about 20°. In particular, the detaching angle may be in a range from 0° to about 10°. The smaller the detaching angle is, the more easily the three-dimensional objects can be detached from the support device.

It is favorable if the apparatus comprises a detaching angle setting device for setting the detaching angle. This makes it possible, in particular, to vary the detaching angle as necessary. In particular, a change in the detaching angle may be advantageous when the solidifiable material in the use of the apparatus is changed. In particular, three-dimensional objects having different hardnesses can thus be detached with different detaching angles between detaching element and support device. The greater the cutting angle is and thus necessarily the detaching angle, the less wear on the cutting edge there typically is. The smaller the cutting angle is, the greater wear and greater risk of damage to the cutting edge there is.

The detaching device can be formed in a particularly simple and cost-effective manner if the detaching angle is unchangeable.

The detaching device preferably comprises two detaching elements, which are arranged at a distance from one another. This makes it possible to introduce the two detaching elements one after the other between the three-dimensional object and the support device in order to separate same from one another. Providing two detaching elements, optionally more, can ensure a particularly clean detachment of the three-dimensional object from the support device. Thus, further three-dimensional objects can be formed directly after the detachment. A further cleaning of the support device or the support face thereof is then not absolutely necessary.

In order to achieve a clean separation of the three-dimensional object from the support device, it is favorable if the two cutting edges of the two detaching elements are arranged at a distance from one another and if the two cutting edges define a cutting edge plane that extends in parallel or substantially in parallel to the support face. For example, both cutting edges may abut against the face or be arranged at a small distance therefrom. As described above, the three-dimensional object that is formed can thus be separated from the support device entirely or except for a small part remaining on the support face.

Further, it may be advantageous if the cutter comprises a serrated cutting edge with a plurality of cutting edge portions arranged offset in parallel to one another, and if the cutting edge portions define a common cutting edge plane, which extends in parallel or substantially in parallel to the support face. A cutting edge serrated in that way can advantageously be used, in particular, when the support device, for example a support plate thereof, has recesses. First layers of the three-dimensional object may form projections that dip or project into these recesses, which would be removed by a continuous cutting edge. In particular, the serrated cutting edge may be arranged in such a way that cutting edge portions that form cutting edge portions of the serrated cutting edge that protrude furthest come into contact with the three-dimensional object first. Said portions can then come into contact with regions of the three-dimensional object that do not project into the recesses of the support device. The recessed cutting edge portions can then be pushed between the already raised underside of the three-dimensional object and the support face without unintentionally damaging the three-dimensional object. The detachment of three-dimensional objects from support plates with recesses can be improved in a simple manner by such a serrated cutting edge.

It is advantageous if the cutting edge has front cutting edge portions and cutting edge portions that are recessed in relation to said front cutting edge portions, and if a cutting angle of the front cutting edge portions is smaller than a cutting angle of the recessed cutting edge portions. The formation of such a serrated cutter has the advantage, in particular, that front cutting edge portions with a smaller cutting angle engage between the three-dimensional object and the support device so that the recessed cutting edge portions can then engage between the already somewhat detached three-dimensional object and the support device. This enables a gentle and secure detachment of three-dimensional objects from a support face of the support device. In particular, the recessed cutting edge portions of a serrated cutting edge can advantageously be used in the case of support plates of support devices that are provided with recesses or perforations in order to not unintentionally separate off projections on the three-dimensional objects.

In order to be able to ensure a secure detachment of three-dimensional objects from the support device, it is advantageous if the at least one detaching element is of elastic configuration. A certain pressing force can thus be exerted against the support device in a simple manner. Thus in addition, in particular, a uniform abutment of the detaching element, for example one or more blades thereof, against the support device can be achieved. In particular, the one or more blades may be of elastic configuration.

It is favorable if the at least one detaching element is made of a detaching element material and if the detaching element material has a modulus of elasticity with a value in a range from about 100000 MPa to about 250000 MPa. In particular, the detaching element material may have a modulus of elasticity with a value in a range from about 170000 MPa to 210000 MPa. Detaching materials with such moduli of elasticity are, in particular, steels that have spring-elastic properties.

Three-dimensional objects can be detached from the support device in a simple and secure manner if the at least one detaching element is made at least in part, in particular the blade, of a metal. Thus, in particular, long service lives for the detaching device can be achieved.

The detaching device can be formed in a cost-effective manner if the metal is a steel. In particular, it may be a spring steel. A spring steel has the advantage, in particular, that the at least one detaching element can be pressed with a defined pretensioning force against the support device.

It is advantageous if the detaching device comprises a pressing device for pressing the at least one detaching element against the support face. In this way, it can be ensured that the cutting edge of the at least one detaching element constantly abuts securely against the support face during the relative movement thereto in order to achieve a defined detachment of the three-dimensional object from the support device.

The pressing device can be formed in a simple manner if it comprises at least one pressing element for pressing the at least one detaching element against the support face. For example, the support device may comprise the pressing device, which presses the support face against the at least one detaching element by means of a drive. A pretensioning force can be set here, in particular, by a travel path of the support device relative to the at least one detaching element when said detaching element is made of an elastic or flexible material.

It is advantageous if the detaching device comprises a holding device for holding the at least one detaching element. In particular, the holding device can be configured to hold the at least one detaching element in a releasably connectible manner. This makes it possible, in particular, to exchange the at least one detaching element, for example if it is damaged, in particular if a cutting edge or a cutting edge portion thereof is dull or broken.

The at least one detaching element is preferably in a holding position is held on the holding device and in a separating position is separated from the holding device. This configuration makes it possible, in particular, to exchange the detaching element in the described manner as necessary.

The holding device and the support device are advantageously arranged so as to be displaceable relative to one another. In this way, in particular, a detaching element held on the holding device can be moved relative to the support device or the support device relative to the at least one detaching element. In particular, the holding device and the support device may be arranged so as to be displaceable relative to one another in parallel to the support face. This makes it possible, in particular, to move the at least one detaching element in parallel to the support face or the support face in parallel to the at least one detaching element, in particular to a cutting edge or a cutting edge portion thereof.

In accordance with a preferred embodiment of the invention, provision may be made that the detaching device, in particular the at least one detaching element, and the support device in a building position, in which at least one three-dimensional object is formed by solidifying, in particular in layers or continuously, the material that is solidifiable by radiation, are out of engagement and in a detaching position, in which the at least one three-dimensional object is separated from the support device, are in contact with one another. The detaching element and the support device can cooperate in the described manner for detaching the at least one three-dimensional object from the support device. In the building position, the detaching device may be arranged, in particular, retracted and optionally also protected so as to enable unobstructed solidification of the material to be solidified for forming at least one three-dimensional object.

It is favorable if the apparatus comprises a protective device for protecting the detaching device, in particular in the building position. The protective device may serve, in particular, to protect the detaching device from contamination with solidifiable material, which, in particular, could impair a cutting effect of a detaching element having a cutter.

Preferably, the protective device comprises at least one protective element for protecting the at least one detaching element. In particular, the at least one protective element may be configured to protect the blade. In this way, contamination of or damage to the at least one detaching element in the building position can be prevented or at least a risk of contamination or damage can be reduced.

In accordance with a further preferred embodiment, provision may be made that the apparatus comprises a drive device for moving the detaching device and the support device relative to one another. In particular, the drive device enables transferring the apparatus from the building position into the detaching position and vice versa. The drive device may be coupled, in particular, directly or indirectly to the detaching device and/or to the support device in order to enable the relative movement thereof. Said drive device may also optionally be coupled only to the detaching device or only to the support device in order to move only the detaching device or only the support device.

It is advantageous if the drive device is configured to cooperate with the holding device for moving the holding device relative to the apparatus. In particular, the drive device can move the holding device relative to the support device.

It is advantageous if the at least one drive device is configured to cooperate with the support device for moving the support device relative to the apparatus in parallel to the support face. For example, the detaching device may be arranged or formed in a stationary manner, in particular immovable relative to the apparatus. For detaching a three-dimensional object from the support device, the support device can then be moved by means of the at least one drive device, in particular relative to the detaching device.

It is favorable if the apparatus comprises a container for the solidifiable material and if the support device is arranged so as to be moveable in a direction parallel or substantially parallel to the direction of gravity and counter or substantially counter to the direction of gravity. This configuration makes it possible, in particular, to solidify solidifiable material, which is accommodated in the container, in layers and to thus form three-dimensional objects on the support device. The support device can then travel in parallel or oppositely parallel to the direction of gravity, so that the three-dimensional object can further be formed in layers or continuously.

It is favorable if the apparatus comprises a collection container for the three-dimensional object that has been detached from the support device. By means of the collection container, it can be prevented, in particular, that the detached three-dimensional object is able to fall into the container for the solidifiable material after being detached from the support device. The collection container may be arranged or formed, in particular, spatially next to the container for the solidifiable material, in particular beneath the at least one detaching element, so that the detached three-dimensional object is able to fall automatically from the support device, which is moved over the at least one detaching element, into the collection container.

So that non-solidified solidifiable material is able to drain out of the collection container, it is favorable if the collection container, in particular a base thereof, is perforated. This configuration facilitates, in particular, cleaning the detached three-dimensional object of not yet solidified solidifiable material.

In order to facilitate the drainage of non-solidified solidifiable material out of the collection container, it is advantageous if the collection container has a base that is inclined in relation to the direction of gravity.

In accordance with a further preferred embodiment of the invention, provision may be made that the at least one detaching element is immovably arranged or formed on the apparatus, in particular relative to the container for the solidifiable material, and that the support device is arranged on the apparatus so as to be moveable in a direction or a plane transverse to the direction of gravity. The at least one detaching element may be arranged on the apparatus, in particular, spatially next to the container for the solidifiable material. For detaching the three-dimensional object from the support device, the support device can be moved transversely to the direction of gravity over the detaching element in order to detach the three-dimensional object. If the at least one detaching element is arranged next to the container for the solidifiable material, the detached three-dimensional object cannot fall into said container. In addition, it is then simpler to arrange a collection container or a conveying device beneath the detaching element to catch the detached three-dimensional object and optionally to further transport same.

It may be further advantageous if the at least one detaching element is arranged on the apparatus so as to be moveable in a plane or direction that extend transversely to the direction of gravity. In particular when the support device can only be moved in parallel to the direction of gravity and counter thereto, it is thus possible to move the at least one detaching element past the support device in order to detach the three-dimensional object held on the support device.

The collection container is preferably arranged on the apparatus so as to be moveable in a plane or direction that extend transversely to the direction of gravity. This configuration is advantageous, in particular, when the at least one detaching element is also arranged on the apparatus so as to be moveable in a plane or direction that extend transversely to the direction of gravity. The collection container can then be moved into a position beneath the support device so that the three-dimensional object that has been separated off with the at least one detaching element can be caught with the collection container.

It is favorable if the collection container is arranged so as to be moveable synchronously with or independently of the at least one detaching element. A synchronous mobility has the advantage, in particular, that the collection container is always automatically moved, for example coupled with a movement of the at least one detaching element, to where the three-dimensional object is detached from the support device, such that the detached three-dimensional object can be caught in the collection container in a simple and secure manner. A mobility of the collection container independent of the at least one detachment element has the advantage, in particular, that it only has to be moved into a catching position when a three-dimensional object is actually detached from the support device.

It is favorable if the collection container is arranged beneath the at least one detaching element in relation to the direction of gravity or is moveably arranged beneath said detaching element. Three-dimensional objects that have been detached can thus fall directly into the collection container due to the gravitational force acting on them.

In accordance with a further preferred embodiment of the invention, provision may be made that the apparatus comprises a conveying device for the three-dimensional object that has been detached from the support device. The conveying device may be configured, in particular, in the form of a conveyor belt or comprise such a one. By means of the conveying device, detached three-dimensional objects can be further transported, in particular, in a quick and simple manner, for example to a post-treatment apparatus in the form of a subsequent exposure apparatus with which the detached three-dimensional object can be completely cured, if that is not already the case.

It is further favorable if the apparatus comprises a turning device for turning the three-dimensional object that has been detached from the support device. For example, the turning device may be configured to turn the three-dimensional object collected in the collection container, for example by 180°. The turning device may also be configured, in particular, to turn the detached three-dimensional object collected on a conveying device, in particular by 180°. For example, the turning device may be configured in the form of a pivoting flap or comprise such a one, onto which the three-dimensional detached object falls after detachment from the support device and which, for turning same about a pivot axis extending transversely to the direction of gravity, is pivoted or folded over by an angle of at least 90°, preferably at least 120°.

The present invention further relates to an apparatus for manufacturing a three-dimensional object by solidifying, in particular in layers or continuously, a material that is solidifiable by radiation, which apparatus comprises a support device for holding the solidified three-dimensional object, wherein the apparatus comprises a detaching device for automatically detaching a three-dimensional object held on the support device, wherein the detaching device comprises at least one detaching element, wherein the at least one detaching element and the support device are arranged or formed so as to be moveable relative to one another, wherein the at least one detaching element comprises a blade with a cutter, or wherein the at least one detaching element is configured in the form of a blade with at least one cutter, the at least one detaching element and a support face, defined by the support device, on which the three-dimensional object is held form a detaching angle, wherein the apparatus comprises a detaching angle setting device for setting the detaching angle.

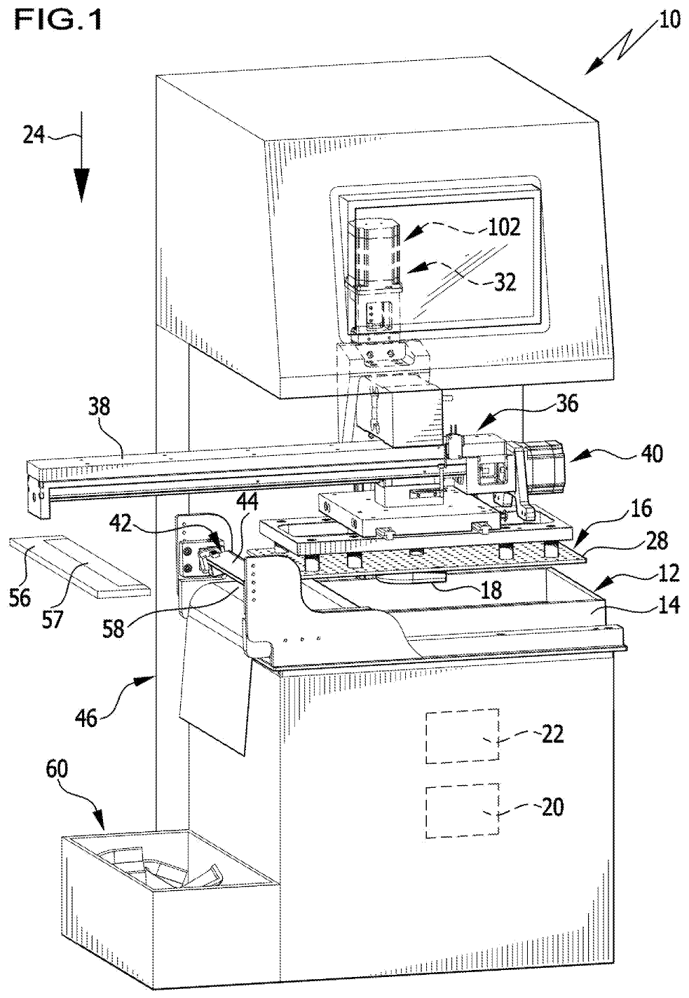

Depicted in FIG. 1 is a first embodiment of an apparatus 10 for manufacturing three-dimensional objects by solidifying, in particular in layers or continuously, a material that is solidifiable by radiation.

The apparatus 10 comprises a container 12 for the solidifiable material. Said container 12 is configured in the form of a flat tray 14.

The apparatus 10 further comprises a support device 16 for holding a solidified three-dimensional object 18.

The solidifiable material is not depicted in the Figures for the sake of clarity.

The apparatus 10 comprises a radiation source 20, schematically depicted in FIG. 1, for generating electromagnetic radiation for solidifying the solidifiable material. The radiation is imaged in a building plane by means of an imaging device 22, which is also schematically depicted in FIG. 1. Said building plane extends transversely to the direction of gravity, which is symbolized by the arrow 24. The radiation source 20 and the imaging device 22 form a part of an exposure device for selectively exposing the building plane.

A base 26 of the container 12 is configured to be permeable to radiation, such that the radiation source 20 arranged beneath the container 12 in the direction of gravity can solidify the solidifiable material contained in the tray 14 from the bottom by exposure to radiation.

The support device 16 comprises a support plate 28, which defines a planar support face 30 that faces in the direction toward the tray 14.

The apparatus 10 comprises a drive device 32 for displacing the support device 16 on a holding frame in order to move the support device 16 in a direction parallel or substantially parallel to the direction of gravity and counter or substantially counter to the direction of gravity.

The support device 16 moveably arranged on the holding frame 34 comprises a slide arrangement 36, oriented transversely to the direction of gravity, with a guide rail 38, which extends transversely to the direction of gravity and serves to displaceably mount the support plate 28. A further drive device 40 enables a controlled relative movement of the support plate 28 transverse to the direction of gravity.

The apparatus 10 further comprises a detaching device 42 for automatically detaching a three-dimensional object 18 held on the support device 16.

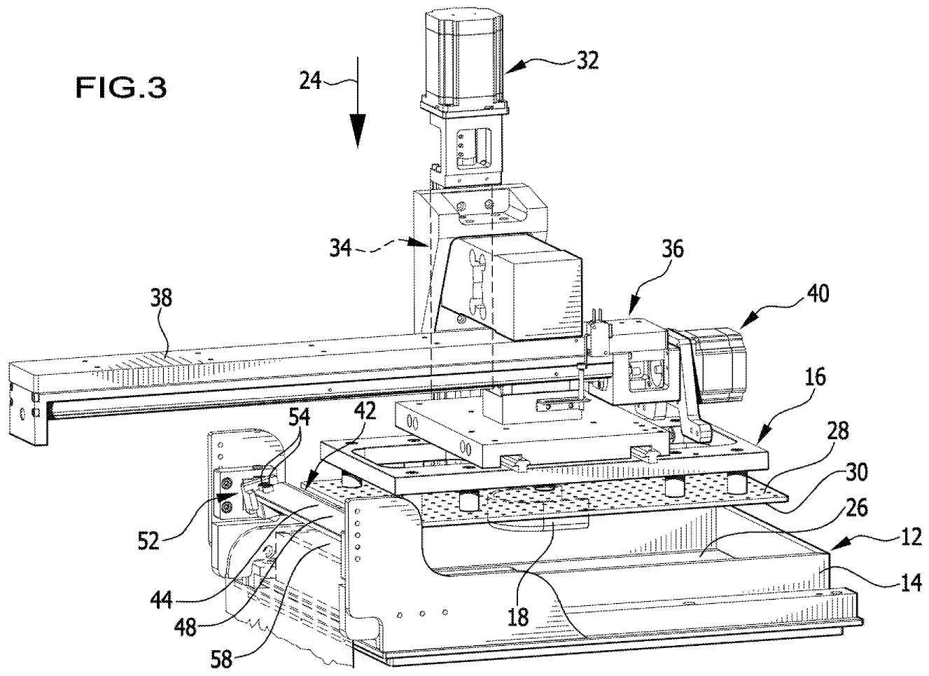

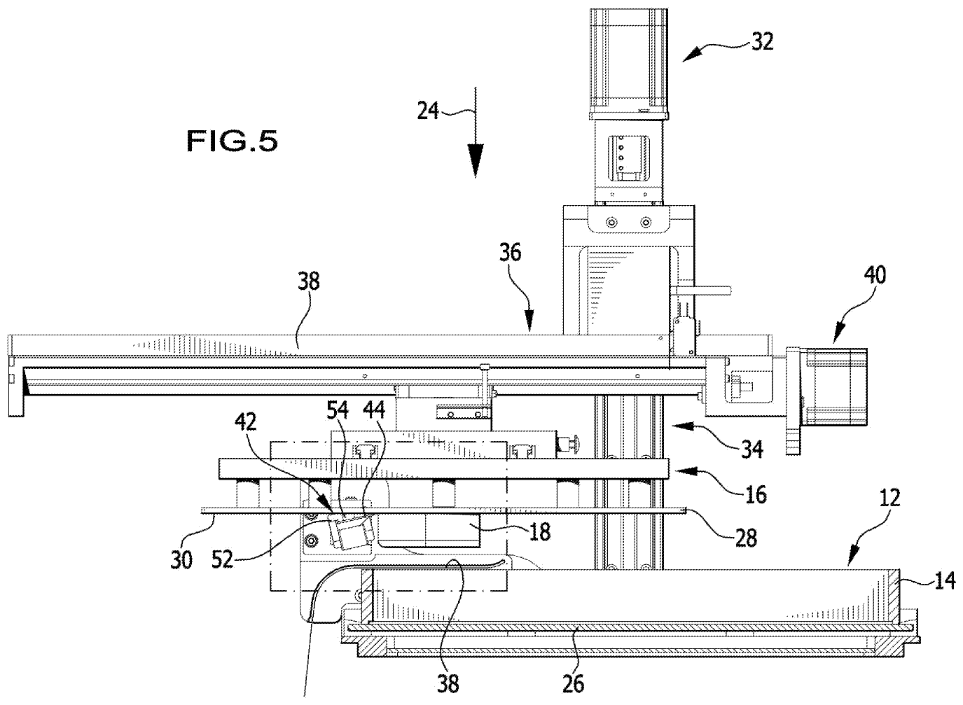

In the embodiment of an apparatus 10, depicted for example in FIGS. 1 to 8, the detaching device 42 comprises a detaching element 44. The support device 16, namely the part thereof that comprises the support plate 28, is arranged so as to be moveable relative to the detaching element 44. This is achieved by the detaching element 44 being immovably fixed to a frame 46 of the apparatus 10. The support plate 28 is arranged so as to be displaceable relative to the frame 46, as described above, transversely to the direction of gravity.

The detaching element 44 comprises a blade 48 with a cutter 50 that faces in a direction toward the support plate 28.

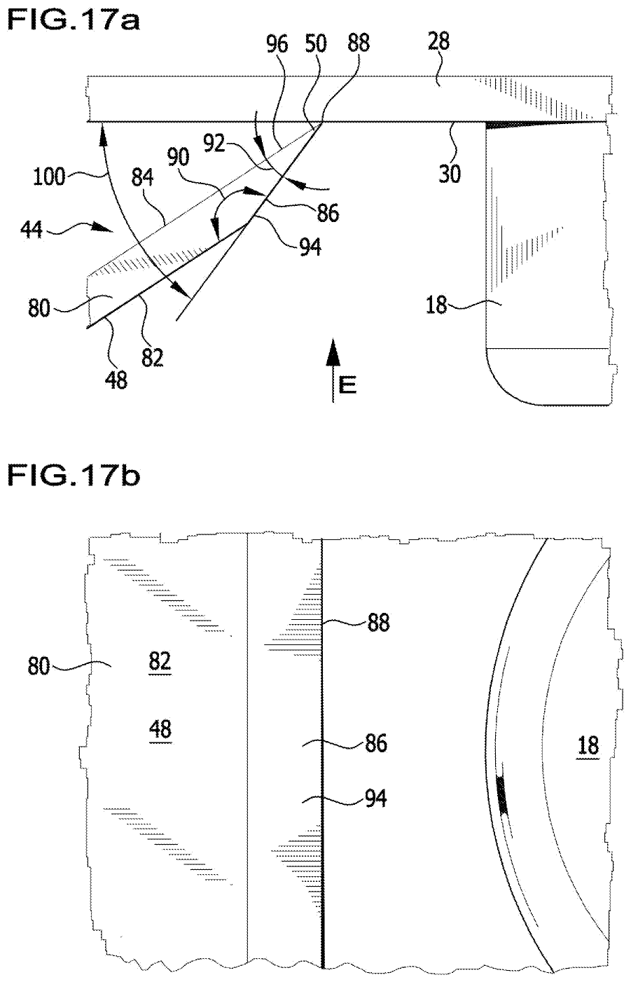

The configuration of the blade 48 is explained in detail later in connection with FIGS. 17a to 20b.

In the embodiment of the apparatus 10 depicted in FIGS. 1 to 8, the detaching element 44 is aligned in an orientation relative to the direction of gravity that is unchangeable.

The detaching device 42 comprises a holding device 52 for holding the detaching element 44. In a holding position, as it is depicted for example in FIGS. 1 to 8, the holding element 44 is held on the holding device 52. In a separating position, which is not depicted in the Figures, the detaching element 44 is completely separated from the holding device 52.

The detaching element 44 is fixed to the holding device 52 with screws 54.

The holding device 52 is arranged on the frame 46 such that support device 16 with its part comprising the support plate 28 is arranged so as to be displaceable relative to the holding device 52, namely in parallel to the support face 30.

The apparatus 10 is configured in such a way that, in a building position in which the object 18 is formed by solidifying the material that is solidifiable by radiation, the detaching device 42 with the detaching element 44 and the support device 16 are out of engagement. FIGS. 1 to 3 show the building position as an example.

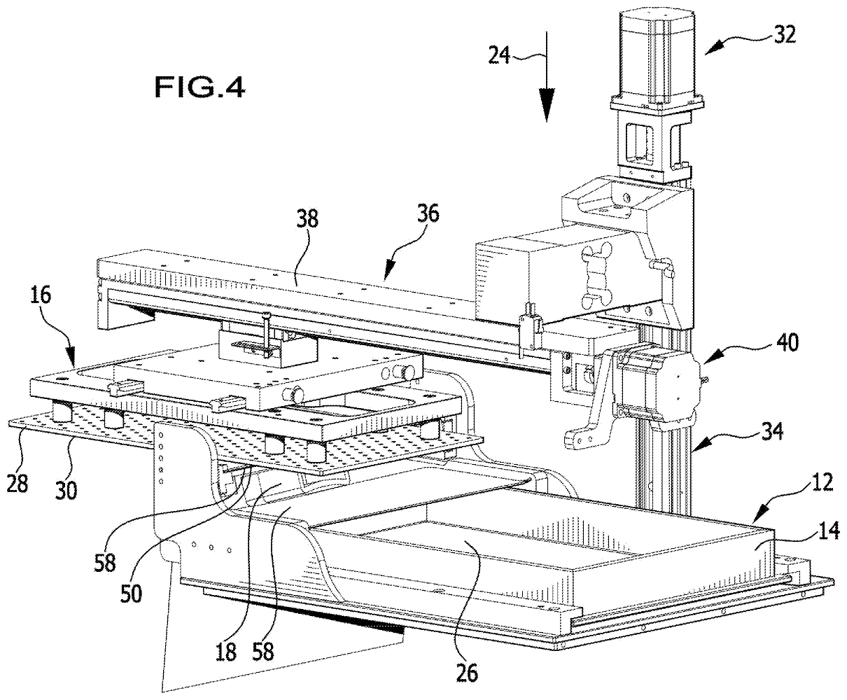

For detaching the object 18 held on the support plate 28, the detaching device 42 with the detaching element 44 in a detaching position in which the object 18 is separated from the support device 16, namely from the support face 30 of the support plate 28 is brought into contact with the support plate 28. FIGS. 4 to 8 show for example various detaching positions, wherein the detaching element 44 engages on the support plate 28 at different positions.

The apparatus 10 may optionally comprise a protective device 56, which is schematically depicted in FIG. 1. It serves to protect the detaching device 42. In particular, the protective device 56 may cover the detaching element 44 in the building position, in particular in order to protect the cutter 50 from damage.

The protective device 56 comprises a protective element 57 for protecting the detaching element 44, in particular for protecting the blade 48.

As described, the drive device 40 serves to move the detaching device 42 and the support device 16, with its part comprising the support plate 28, relative to one another. In the embodiment of the apparatus 10 depicted in FIGS. 1 to 8, the drive device 40 is configured to cooperate with the support device 16 for moving the support device 16, with its part comprising the support plate 28, relative to the apparatus 10, in particular relative to its frame 46, in parallel to the support face 30.

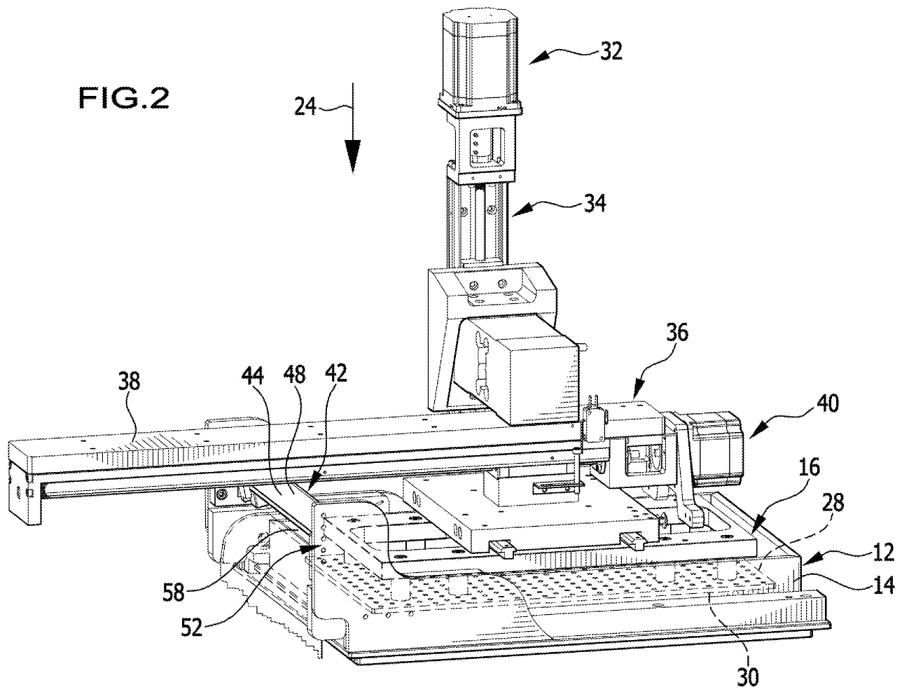

For forming the three-dimensional object, as schematically depicted in FIG. 2, the support plate 28 is moved into the tray 14 by means of the drive device 32 until the support face 30 is in contact with solidifiable material.

The solidifiable material can now be exposed in the desired manner by means of the radiation source 20 and the imaging device 22, namely in a plane directly adjoining the support face 30, i.e., the building plane, such that a first layer of solidifiable material is formed directly on the support face 30 of the support plate 28.

The support device 16 is now moved in steps or continuously by the drive device 32 out of the tray 14, wherein the solidifiable material is acted upon with radiation in layers or continuously for solidifying the solidifiable material to form the object 18.

When the object 18 is completed, the support device 16 with the support plate 28 is moved so far out of the tray 14 that the support plate 28 can be displaced by means of the drive device 40 in parallel to the support face 30 in the direction toward the detaching device 42 until the detaching element 44 comes into contact with the support plate 28.

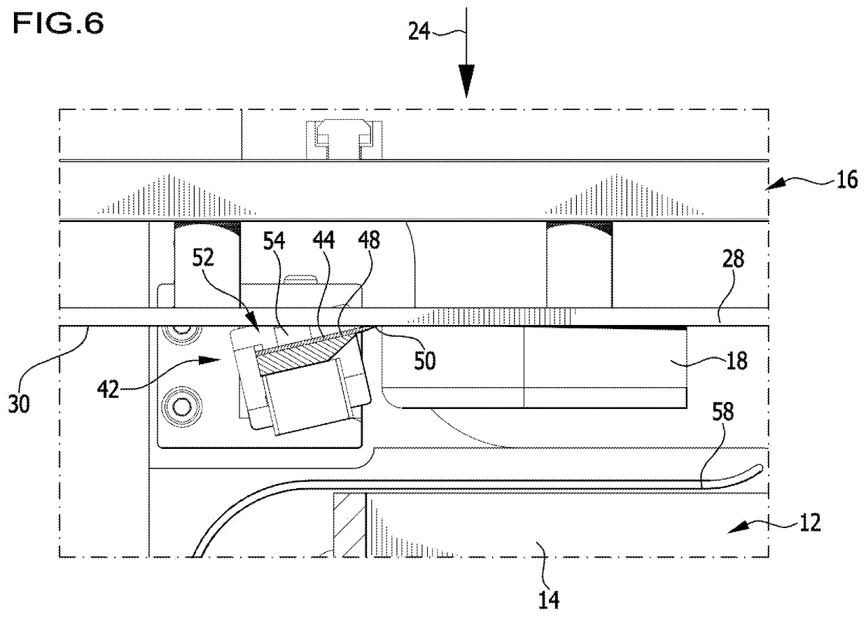

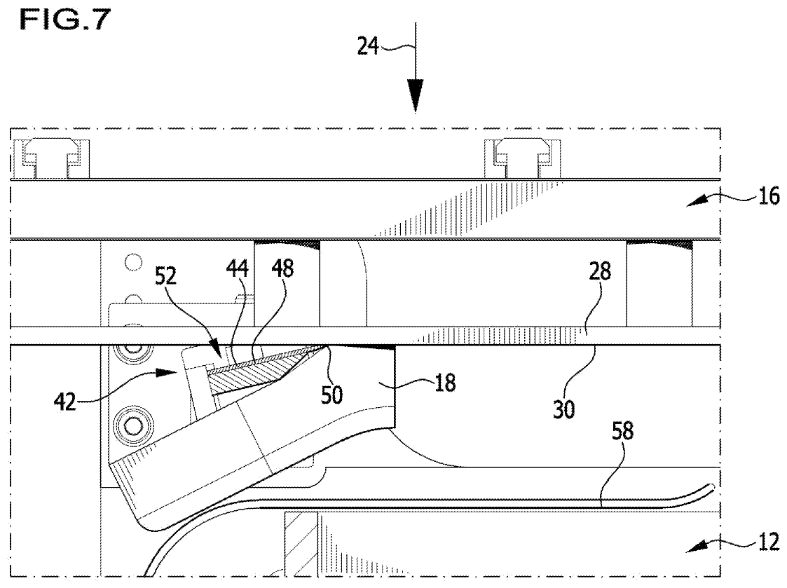

While the support plate 28 is progressively displaced over the detaching element 44, the blade 48 is pushed between the object 18 and the support face 30, as is schematically depicted in FIGS. 6 and 7.

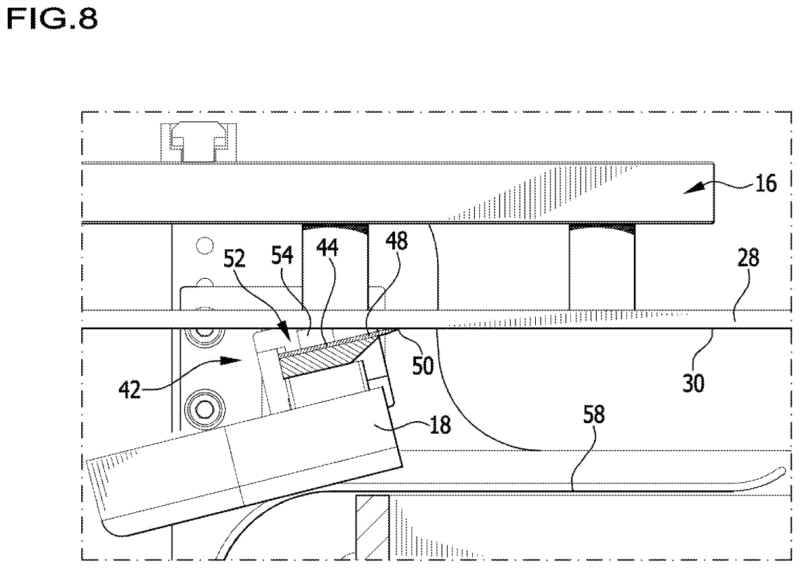

As soon as the detaching element 44 has completely scraped off the object 18 from the support face 30, as is schematically depicted in FIG. 8, the object 18 falls onto an impact face 58, from where it can fall into a catching container 60.

The support plate 28 freed of the object 18 in the described manner can now travel by means of the drive device 40 back into a position from which it can be moved back into the container 12 by means of the drive device 32.

Thus, by means of the apparatus 10, three-dimensional objects can be manufactured in practically any shape and be automatically detached from the support device 16. This enables a continuous manufacturing process. A manual detachment of the objects 18 from the support plate 28 is not necessary.

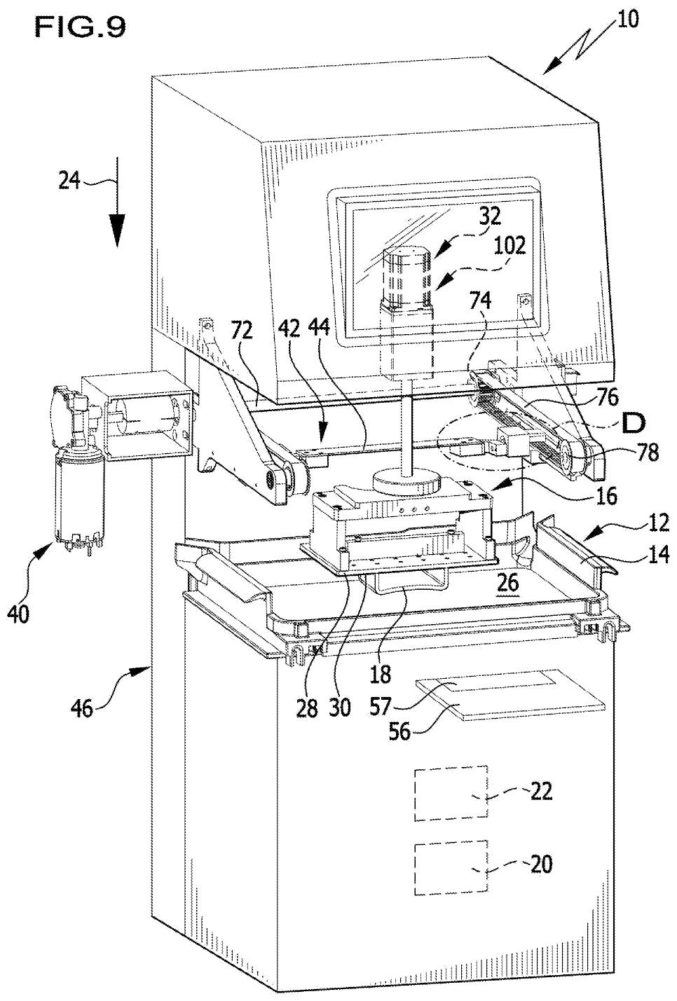

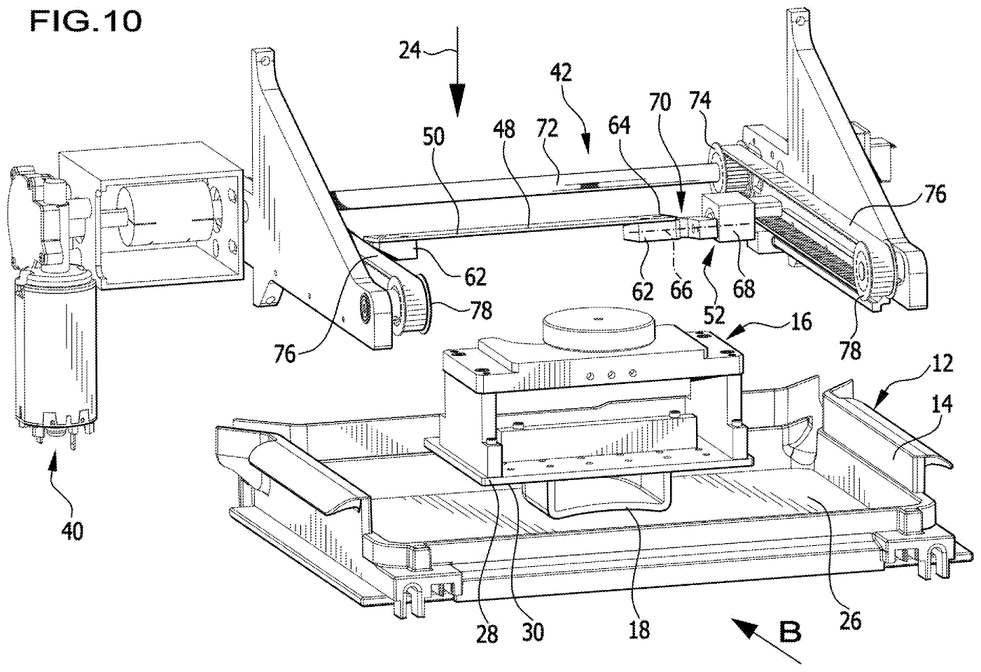

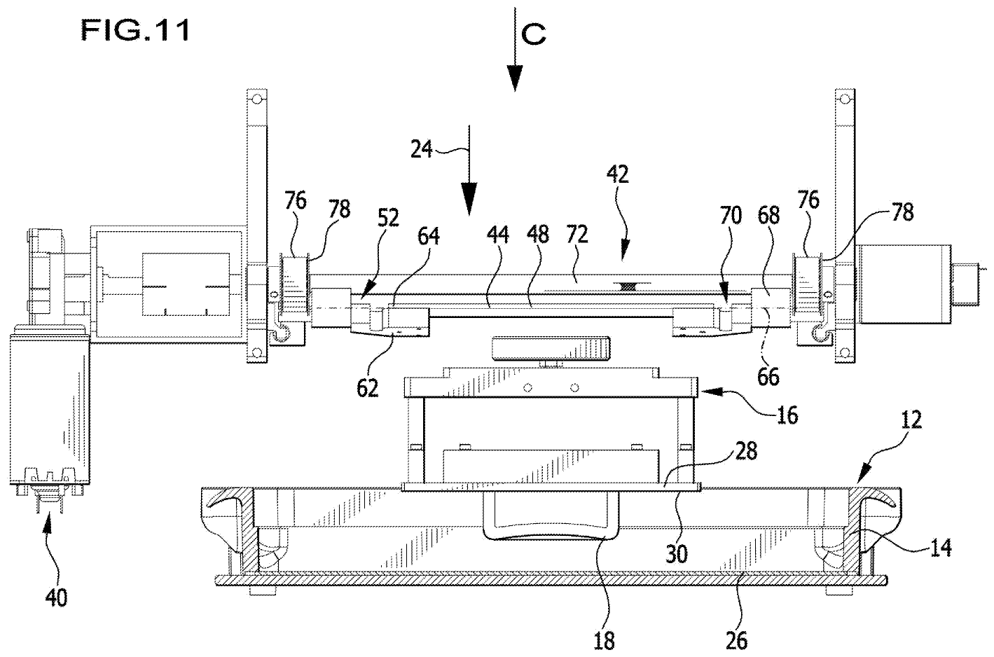

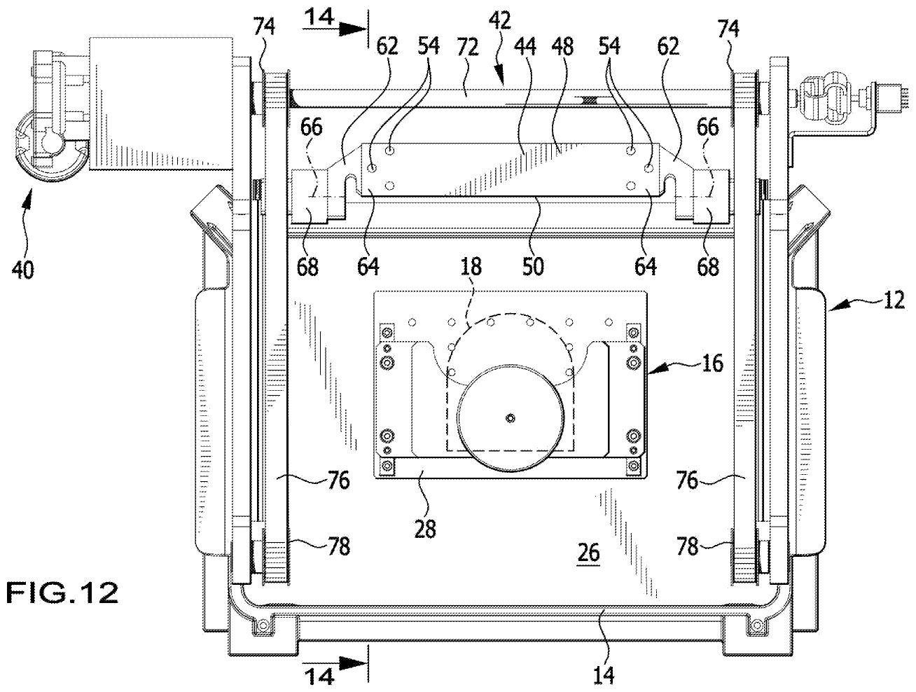

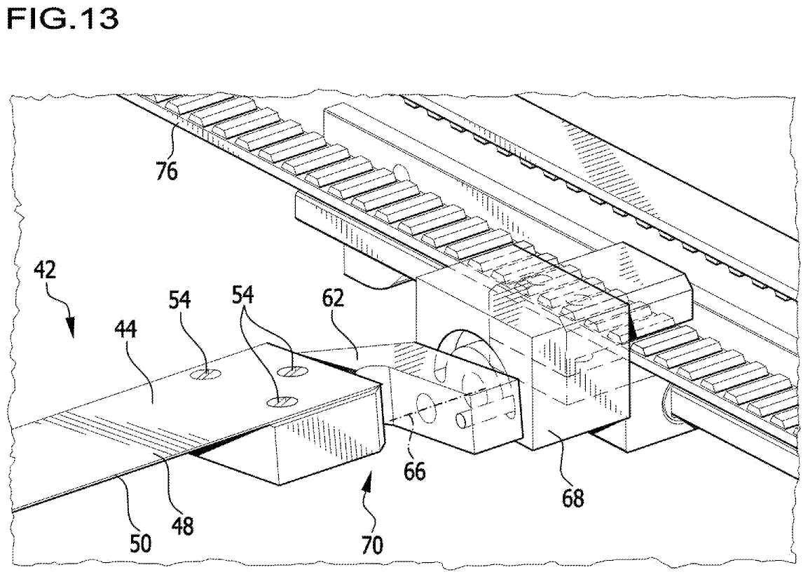

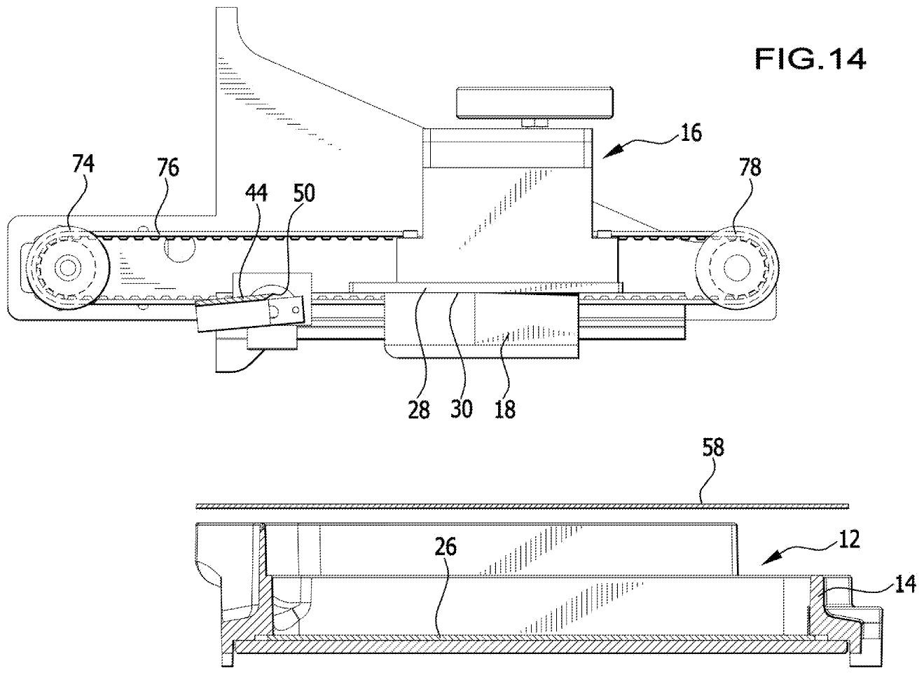

A second embodiment of an apparatus 10 for manufacturing a three-dimensional object 18 by solidifying a material that is solidifiable by radiation is schematically depicted in FIGS. 9 to 16. Identical or functionally comparable components are provided with the same reference numerals in the embodiment depicted in FIGS. 9 to 16 as in the embodiment of the apparatus 10 depicted in FIGS. 1 to 8.

The further embodiment of the apparatus 10 is explained in more detail in the following in conjunction with FIGS. 9 to 16.

A drive device 32 is arranged on a frame 16 for moving a support device 16 with a support plate 28, which comprises a support face 30 that faces in a direction toward a container 12 for accommodating solidifiable material, in parallel to and counter to the direction of gravity, symbolized by the arrow 24. Here, the support plate 28 can be moved exclusively in parallel to the direction of gravity or counter thereto.

The apparatus 10 also comprises a detaching device 42 with a detaching element 44. The detaching element 44 is configured in the form of a blade 48 with a cutter 50.

The detaching element 44 is exchangeably fixed to a holding device 52 by means of screws 54.

The holding device 52 comprises two mutually spaced holding elements 62, on which in each case one of two end regions 64 that face away from one another are fixed with the screws 54.

The holding elements 62 are each held on a bearing body 68 so as to be pivotable about a pivot axis 66.

The holding elements 62 and the bearing bodies 68 cooperating therewith together form a detaching angle setting device 70 for setting an orientation of the detaching element 44 relative to the direction of gravity.

The holding device 52 is configured to interact with a drive device 40. The drive device 40 drives a drive shaft 72 on which two gears 74 are spaced at a distance from one another and are held in a rotationally fixed manner, such that they can be set into rotation synchronously with the drive device 40. The gears 74 serve to drive a respective toothed belt 76. The toothed belts 76 are each tensioned by way of a further gear 78.

The bearing bodies 68 are each fixed to one of the two toothed belts 76, such that as a result of a rotation of the drive shaft 72, the toothed belts 76 can be moved and the bearing bodies 68 can thereby be displaced transversely to the direction of gravity. Here, the blade 48 fixed to the holding device 52 is then also displaced transversely to the direction of gravity.

For detaching a three-dimensional object 18 from the support plate 28, the support device 16 is moved by means of the drive device 32 counter to the direction of gravity out of the container 12, namely so far that the support face 30 is positioned at the same height as the cutter 50 of the blade 48.

The detaching element 44 is now moved, namely in parallel to the support face 30, by means of the drive device 40. In this way, the holding device 52 is moved relative to the apparatus 10, for example the frame 46 thereof.

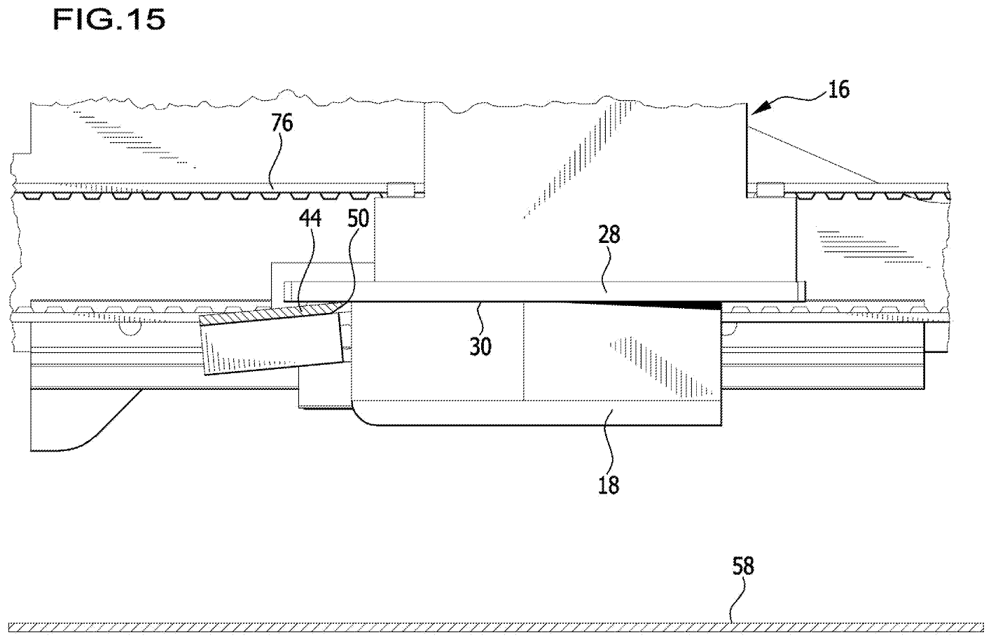

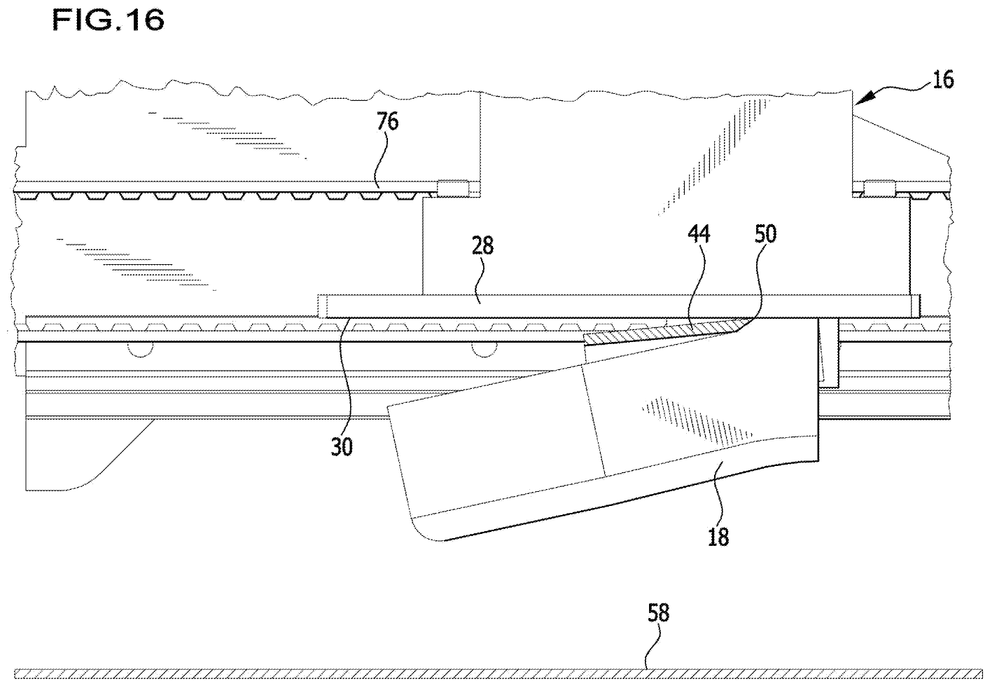

Commencing from a building position that is schematically depicted in FIGS. 9 to 12, in which position the detaching element 44 and the support device 16 are out of engagement, the holding device 52 is moved with the detaching element 44 into the detaching position, in which the object 18 is separated from the support device 16. The detaching element 44 is thereby in contact with the support face 30. This is depicted schematically in FIGS. 15 and 16. The blade 48, in turn, is hereby pushed between the object 18 and the support face 30 and scrapes the object 18, as schematically depicted in FIG. 16, off of the support plate 28.

With the apparatus 10 schematically depicted in FIGS. 9 to 16, as well, three-dimensional objects can be manufactured in a fully automated manner and be automatically separated from the support device 16 by means of the detaching device 42. This enables a continuous manufacturing process that is performable in a fully automated manner.

Various embodiments of detaching elements 44 are described in the following in conjunction with FIGS. 17a to 20b.

An embodiment of a detaching element 44 in the form of a blade 48 is depicted in FIG. 17a. The blade 48 comprises a blade body 80 with a blade body front side 82 and a blade body rear side 84. The blade body 80 has a side face 86 that is beveled in relation to the blade body front side 82 for forming the cutter 50 with a cutting edge 88.

The beveled side face 86 forms an oblique angle 90 with the blade body front side 82.

The blade body 82 has only the one beveled side face 86, which forms an acute angle 92 with the blade body rear side 84. A line of intersection of the beveled side face 86 and the blade body rear side 84 defines the cutting edge 88.

The blade body front side 82 and the blade body rear side 84 extend in parallel to one another.

The cutting edge 88 is defined by intersecting cutting faces 94 and 96 that delimit the cutter 50 and intersect at a cutting angle 98. The two cutting faces 94 and 96 are defined by the beveled side face 86 and the blade body rear side 84. The acute angle 92 thus defines the cutting angle 98.

The cutting angle 98 preferably has a value in a range from 10° to about 50°.

For detaching the object 18, the detaching element 44 abuts with the cutting edge 88 against the support face 30 of the support device 16. Alternatively, the detaching element 44 may also be arranged at a small distance between the cutting edge 88 and the support device 16.

The detaching element 44 and the support face 30 of the support device 16 form a detaching angle 100. Said angle is delimited by the cutting face 94, which faces away from the support face 30, and the support face 30.

The embodiment of the blade 48 depicted in FIGS. 17a and 17b is configured in such a way that the beveled side face 86 and the support face 30 form the detaching angle 100.

Both in this embodiment and in the three further embodiments, which will be described in the following, the detaching angle 100 is preferably in a range from 0° to about 20°.

In the embodiment of the apparatus 10 depicted in FIGS. 9 to 16, the detaching angle 100 is settable. By contrast, the detaching angle 100 in the embodiment of the apparatus 10 depicted in FIGS. 1 to 8 is unchangeable.

The detaching element 44 is of elastic configuration.

The detaching element 44 is made of a detaching element material, which has a modulus of elasticity with a value in a range from about 100000 MPa to 250000 MPa.

The detaching element 44, namely the blade 48 comprised thereby, is made of a metal. The metal is a steel, namely a spring steel.

In both described embodiments of the apparatus 10, the detaching device 42 comprises a pressing device 102 for pressing the detaching element 44 against the support face 30. In each case, the pressing device 102 comprises the drive device 32 with which the support plate 28 can be pressed against the detaching element 44. The elastic detaching element 44 is thus pressed under a slight pretension with the cutting edge 88 against the support face 30.

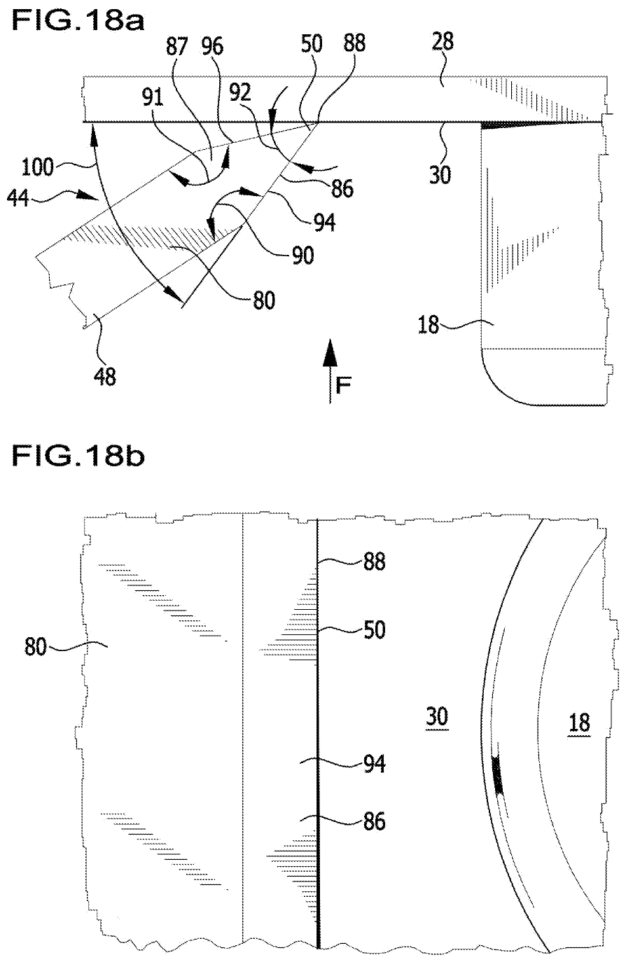

A further embodiment of a detaching element 44 in the form of a blade 48 is depicted in FIGS. 18a and 18b.

Here, the blade body 80 has two beveled side faces 86 and 87, which define the cutting faces 94 and 96. The cutting faces 94 and 96 intersect in the cutting edge 88.

Both the side face 86 and the side face 87 form an acute angle 90 and 91, respectively, with the blade body front side 82 and the blade body rear side 84, respectively.

The detaching angle 100, in turn, is defined between the cutting face 94 and the support face 30.

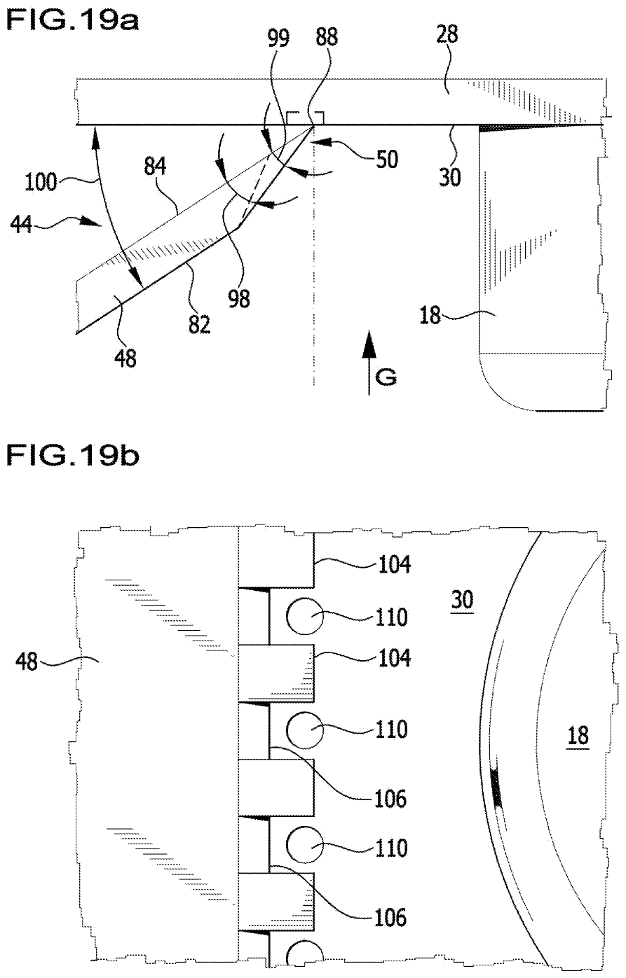

The embodiment of a detaching element 44 depicted in FIGS. 19a and 19b comprises a cutter 50 with a serrated cutting edge 88 that comprises a plurality of cutting edge portions 104 and 106 arranged offset in parallel to one another, which define a common cutting edge plane 108. Said cutting edge plane 108 may extend in parallel to the support face 30 or be inclined relative thereto. In the embodiment of the detaching element 44 depicted in FIGS. 19a and 19b, the cutting edge plane 108 is defined by the blade body rear side 84.

The cutting edge 88 has front cutting edge portions 104 and cutting edge portions 106 that are recessed in relation to said cutting edge portions 104. A cutting angle 98 of the front cutting edge portions 104 is smaller than a cutting angle 99 of the recessed cutting edge portions 106.

For detaching the object 18 as schematically depicted in FIG. 19b, the serrated cutting edge 88 is preferably positioned such that front cutting edge portions 104 engage between perforations 110 of the support plate 28. If the object 18 forms projections that project into the perforations 110, the object 18 is first slightly raised with the cutting edge portions 104 and then subsequently scraped further off of the support face 30 with the cutting edge portions 106 traveling over the perforations 110.

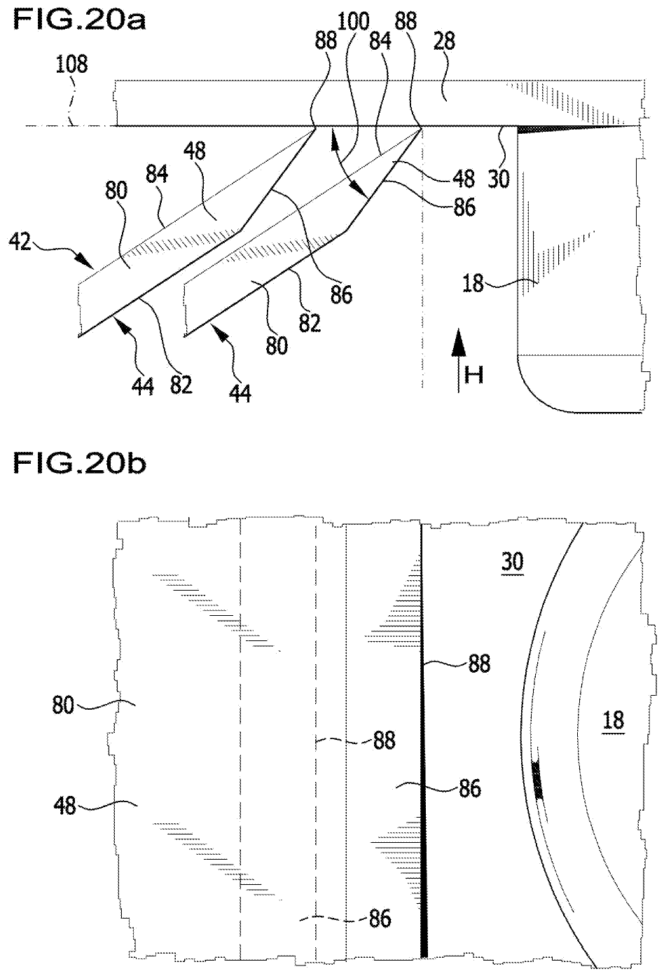

The embodiment of a detaching device 42 schematically depicted in FIGS. 20a and 20b comprises two detaching elements 44. Said detaching elements 44 are arranged at a distance from one another. The detaching elements 44 may be configured, in particular, in the form of the embodiments of detaching elements 44 that are schematically depicted in FIGS. 17a to 19b.

For detaching the object 18, the cutting edges 88 abut against the support face 30. The two cutting edges 88 define a cutting edge plane 108, which is defined by the support face 30.

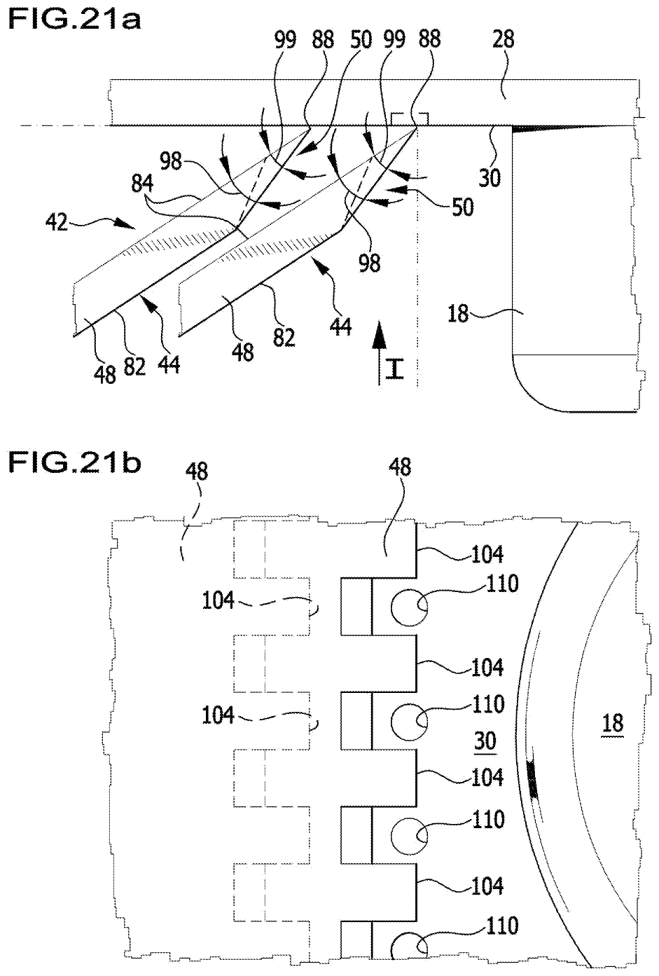

Schematically depicted in FIGS. 21a and 21b is an embodiment of a detaching device 42 with two detaching elements 44. The detaching elements 44 are configured like the detaching element 44 depicted in FIGS. 19a and 19b, which comprises a cutter 50 with a serrated cutting edge 88. Therefore, the same reference numerals are used in FIGS. 21a and 21b to refer to the detaching elements 44 as in FIGS. 19a and 19b.

The two detaching elements 44 are arranged in such a way that the front cutting edge portions 104 are arranged offset relative to one another. The serrated cutting edge 88 of the leading detaching element 44 may, as schematically depicted in FIG. 21b, preferably be positioned such that the front cutting edge portions 104 thereof engage between perforations 110 of the support plate 28. If the object 18 forms projections that project into the perforations 110, the object 18 is first slightly raised with the cutting edge portions 104 and then subsequently scraped further off of the support face 30 with the cutting edge portions 104 of the lagging detaching element 44 traveling over the perforations 110.

The blades 48 of the embodiments of the detaching elements 44 depicted in FIGS. 18a to 21b are made of the detaching elements materials described above and also have the properties described above.

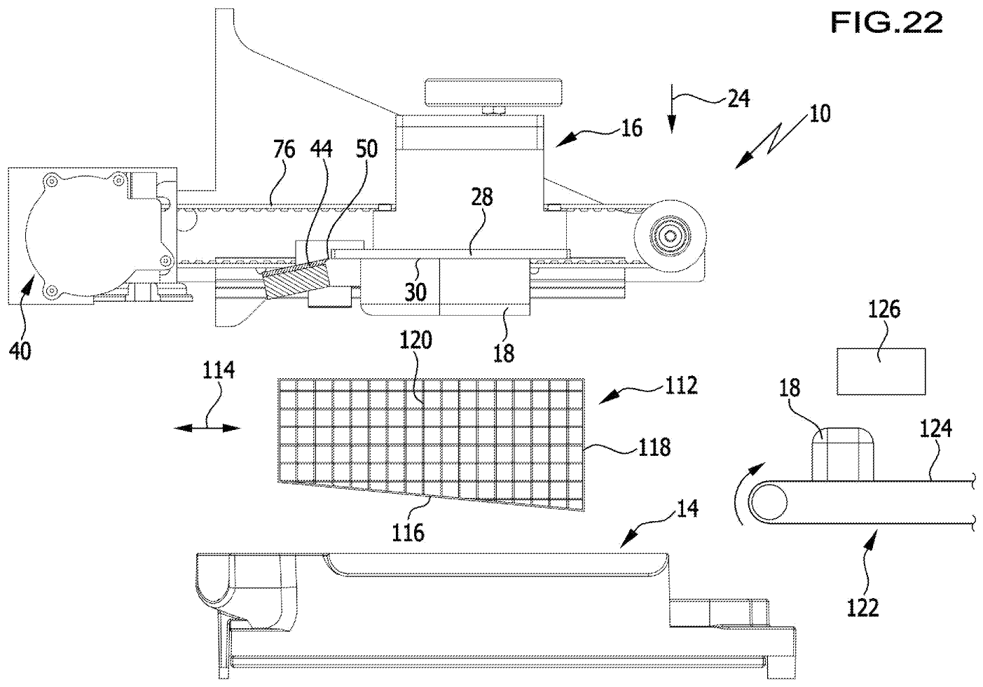

Schematically depicted in FIG. 22 is a further embodiment of an apparatus 10 for manufacturing a three-dimensional object. The embodiment of the apparatus 10 schematically depicted in FIG. 22 corresponds in its structure substantially with the embodiment of the apparatus 10 depicted in FIGS. 9 to 16. Therefore, the same reference numerals are used to refer to the elements depicted in FIG. 22 as in FIGS. 9 to 16.

In addition, in the embodiment of the apparatus from FIG. 22, a collection container 112 is provided that is moveable in a direction or in a plane, which is symbolized by the arrow 114, transversely to the direction of gravity 24, namely beneath the detaching element 44, which is also moveable transversely to the direction of gravity 24 in order to detach a solidified three-dimensional object 18 held to the support surface 30 from the support plate 28.

The collection container 112 has a base 116 that is inclined in relation to the direction of gravity 24 and, like container walls 118 projecting transversely from the base 116 against the direction of gravity 24, is provided with a plurality of perforations 120. The perforations 120 make it possible for not yet solidified solidifiable material to drip off of the object 18 when said object 18 is collected in the collection container 112, and to drain out of the collection container 112, for example into the tray 14.

The collection container 112 can be moved with a drive device, which is not depicted, in a similar manner to the detaching element 44. For example, the collection container 112 may also be held on a toothed belt, which is depicted in FIG. 22 for moving the detaching element 44 and is designated with the reference numeral 76.

The apparatus 10 may further optionally comprise, as schematically depicted in FIG. 22, a conveying device 120 with a conveyor belt 122 onto which the object 18 collected in the collection container 112 can be emptied. For this purpose, the conveyor belt 122 is arranged beneath the moveable collection container 112 in the direction of gravity 24.

In order to bring the objects 18 into the desired orientation, the apparatus 10 may further optionally comprise a turning device 124, which is schematically depicted in FIG. 22 , in order to, for example, turn the objects 18 by 180°. In particular, the turning device 124 may comprise a pivoting flap onto which the object 18 falls after detachment from the support device 16 and which can, in particular, be pivoted or folded over about a pivot axis, extending transversely to the direction of gravity 24, by a pivot angle of at least 90°, preferably at least 120°, for the purpose of turning the object 18.

As already mentioned, the detaching elements 44 of the apparatuses 10, as they have been described in conjunction with FIGS. 1 to 16 and 22, may optionally be configured in the form of one of the embodiments of detaching elements 44 described in connection with FIGS. 17a to 22.

### REFERENCE NUMERAL LIST

10 apparatus
12 container
14 tray
16 support device
18 object
20 radiation source
22 imaging device
24 arrow
26 base
28 support plate
30 support face
32 drive device
34 holding frame
36 slide arrangement
38 guide rail
40 drive device
42 detaching device
44 detaching element
46 frame
48 blade
50 cutter
52 holding device
54 screws
56 protective device
58 protective element
58 impact face
60 catching container
62 holding element
64 end region
66 pivot axis
68 bearing body
70 detaching angle setting device
72 drive shaft
74 gear
76 toothed belt
78 gear
80 blade body
82 blade body front side
84 blade body rear side
86 side face
87 side face
88 cutting edge
90 angle
91 angle
92 angle
94 cutting face
96 cutting face
98 cutting angle
99 cutting angle
100 detaching angle
102 pressing device
104 cutting edge portion
106 cutting edge portion
108 cutting edge plane
110 perforation
112 collection container
114 arrow
116 base
118 container wall
120 perforation
122 conveying device
124 conveyor belt
126 turning device

What is claimed is:

1. An apparatus for manufacturing a three-dimensional object by solidifying, in particular in layers or continuously, a material that is solidifiable by radiation, which apparatus comprises a support device for holding the solidified three-dimensional object, wherein the apparatus comprises a detaching device for automatically detaching a three-dimensional object held on the support device, wherein the apparatus comprises a protective device for protecting the detaching device, in particular in the building position.

2. The apparatus in accordance with claim 1, wherein the detaching device comprises at least one detaching element, wherein the at least one detaching element and the support device are arranged or formed so as to be moveable relative to one another, wherein the at least one detaching element comprises a blade with a cutter, or wherein the at least one detaching element is configured in the form of a blade with at least one cutter.

3. The apparatus in accordance with claim 2, wherein the blade has a blade body with a blade body front side and a blade body rear side, and wherein the blade body has at least one side face that is beveled in relation to at least one of the blade body front side and the blade body rear side for forming the cutter with a cutting edge.

4. The apparatus in accordance with claim 3, wherein the at least one beveled side face forms an obtuse angle with the blade body front side.

5. The apparatus in accordance with claim 2, wherein the blade body
a) has two beveled side faces for forming the cutter, and wherein a line of intersection of the two beveled side faces defines the cutting edge,
wherein, in particular, the at least one beveled side face forms an obtuse angle with the blade body rear side,
or
b) has only one beveled side face, which forms an acute angle with the blade body rear side, and wherein a line of intersection of the beveled side face with the blade body rear side defines with the cutting edge.

6. The apparatus in accordance with claim 3, wherein at least one of
a) the blade body front side and the blade body rear side extend in parallel to one another
and
b) the cutting edge is defined by two intersecting cutting faces that delimit the blade and intersect at a cutting angle, and wherein the cutting angle has a value in a range from about 10° to about 50°, in particular a value in a range from about 20° to about 40°,
and
c) the at least one detaching element, for and when detaching the three-dimensional object, abuts with the cutting edge against the support device or is arranged at a small distance from the support device.

7. The apparatus in accordance with claim 2, wherein the at least one detaching element and a support face, defined by the support device, on which the three-dimensional object is held form a detaching angle, wherein, in particular, at least one of
a) one of the two cutting faces faces away from the support face, and wherein this cutting face and the support face form between them the detaching angle
and
b) the beveled side face facing away from the support face and the support face form the detaching angle
and
c) the detaching angle has a value in a range from about 0° to about 20°, in particular in a range from about 0° to about 10°.

8. The apparatus in accordance with claim 6, wherein the apparatus comprises a detaching angle setting device for setting the detaching angle.

9. The apparatus in accordance with claim 2, wherein the detaching device comprises two detaching elements, which are arranged at a distance from one another,
wherein, in particular, the two cutting edges of the two detaching elements are arranged at a distance from one another, and wherein the two cutting edges define a cutting edge plane, which extends in parallel or substantially in parallel to the support face.

10. The apparatus in accordance with claim 2, wherein the cutter comprises a serrated cutting edge with a plurality of cutting edge portions arranged offset in parallel to one another, and wherein the cutting edge portions define a common cutting edge plane, which extends in parallel or substantially in parallel to the support face,
wherein, in particular, the cutting edge has front cutting edge portions and cutting edge portions that are recessed in relation to said front cutting edge portions, and wherein a cutting angle of the front cutting edge portions is smaller than a cutting angle of the recessed cutting edge portions.

11. The apparatus in accordance with claim 2, wherein the at least one detaching element at least one of
a) is of elastic configuration
and
b) is made of a detaching element material, and wherein the detaching element material has a modulus of elasticity with a value in a range from about 100000 MPa to about 250000 MPa, in particular in a range from about 170000 MPa to about 210000 MPa,
and
c) is made at least in part, in particular the blade, of a metal, wherein, in particular, the metal is a steel, in particular a spring steel.

12. The apparatus in accordance with claim 2, wherein the detaching device comprises a pressing device for pressing the at least one detaching element against the support face,
wherein, in particular, the pressing device comprises at least one pressing element for pressing the at least one detaching element against the support face.

13. The apparatus in accordance with claim 1, wherein the detaching device comprises a holding device for holding the at least one detaching element,
wherein, in particular, at least one of
a) the at least one detaching element in a holding position is held on the holding device and in a separating position is separated from the holding device
and
b) the holding device and the support device are arranged so as to be displaceable relative to one another, in particular in parallel to the support face.

14. The apparatus in accordance with claim 1, wherein at least one of
a) the detaching device, in particular the at least one detaching element, and the support device in a building position, in which at least one three-dimensional object is formed by solidifying, in particular in layers or continuously, the material that is solidifiable by radiation, are out of engagement and in a detaching position, in which the at least one three-dimensional object is separated from the support device, are in contact with one another
and
b) the protective device comprises at least one protective element for protecting the at least one detaching element, in particular for protecting the blade.

15. The apparatus in accordance with claim 1, wherein the apparatus comprises at least one drive device for moving the detaching device and the support device relative to one another,
wherein, in particular, the at least one drive device at least one of
a) is configured to cooperate with the holding device for moving the holding device relative to the apparatus
and
b) is configured to cooperate with the support device for moving the support device relative to the apparatus in parallel to the support face.

16. The apparatus in accordance with claim 1, wherein the apparatus comprises at least one of
a) a container for the solidifiable material, and wherein the support device is arranged so as to be moveable in a direction parallel to or substantially parallel to the direction of gravity and counter to or substantially counter to the direction of gravity
and
b) a collection container for the three-dimensional object that has been detached from the support device,
wherein, in particular, the collection container at least one of
is perforated, in particular a base thereof,
and
has a base that is inclined in relation to the direction of gravity.

17. The apparatus in accordance with claim 2, wherein the at least one detaching element
a) is arranged or formed on the apparatus so as to be immobile, in particular relative to the container for the solidifiable material, and wherein the support device is arranged on the apparatus so as to be moveable in a direction or a plane transverse to the direction of gravity
or
b) is arranged on the apparatus so as to be moveable in a plane or direction that extend transversely to the direction of gravity,
wherein, in particular, the collection container is arranged on the apparatus so as to be moveable in a plane or direction that extend transversely to the direction of gravity,
wherein further, in particular, the collection container is arranged so as to be moveable synchronously with or independently of the at least one detaching element.

18. The apparatus in accordance with claim 1, wherein the apparatus comprises a conveying device, in particular in the form of conveyor belt, for the three-dimensional object that has been detached from the support device.

19. The apparatus in accordance with claim 1, wherein the apparatus comprises a turning device for turning the three-dimensional object that has been detached from the support device.

20. An apparatus for manufacturing a three-dimensional object by solidifying, in particular in layers or continuously, a material that is solidifiable by radiation, which apparatus comprises a support device for holding the solidified three-dimensional object, wherein the apparatus comprises a detaching device for automatically detaching a three-dimensional object held on the support device, wherein the detaching device comprises at least one detaching element, wherein the at least one detaching element and the support device are arranged or formed so as to be moveable relative to one another, wherein the at least one detaching element comprises a blade with a cutter, or wherein the at least one detaching element is configured in the form of a blade with at least one cutter, the at least one detaching element and a support face, defined by the support device, on which the three-dimensional object is held form a detaching angle, wherein the apparatus comprises a detaching angle setting device for setting the detaching angle.
